(19) United States
(12) Patent Application Publication
(10) Pub. No.: US 2010/0327611 A1
(43) Pub. Date: Dec. 30, 2010

(54) ANTI-BARRICADE THUMB-TURN

(76) Inventor: Alan Rees, Wales (GB)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/821,667

(22) Filed: Jun. 23, 2010

(30) Foreign Application Priority Data
Jun. 24, 2009 (GB) 0910917.4

(51) Int. Cl. E05B 63/00

(52) U.S. Cl. 292/336.3

(57) ABSTRACT

An anti-barricade thumb-turn enables operation of the door lock device it is fitted to, even if force is applied to the thumb-turn, and comprises a circular spring component, circular thumb-turn drive plate and circular spindle-drive plate inserted into the circular inner bore of the thumb-turn and secured in position by means of a retaining ring.

### CROSS-REFERENCE TO RELATED APPLICATION

This application claims the benefit of UK Patent Application GB 091 091 7.4, filed on Jun. 24, 2009, the contents of which are hereby incorporated by reference in their entirety.

### FIELD OF THE INVENTION

The present invention relates to thumb-turn mechanisms for door lock devices.

### BACKGROUND OF THE INVENTION

There are numerous styles of thumb-turns commercially available and they are very widely used on doors in public buildings, commercial premises, residential homes, correctional facilities, the education sector and the health service.

Thumb-turns are fitted to doors in conjunction with a locking device such as a barrel cylinder which features a key hole on one end and the thumb-turn knob on the opposite end. Alternatively, the locking device used in bathroom, toilet or changing room facilities commonly features some sort of emergency release on one end (typically a slot turned by a coin or similar shaped object) and the thumb-turn on the opposite end.

Whichever locking device is used, the intention is that the thumb-turn affords the room occupant(s) privacy to lock the door, while the door can still be unlocked from the outside if necessary by operating the key or the release slot. This is particularly desirable in any facility where room access may be required for medical or security reasons, such as hospitals or elderly residencies.

However, currently available standard thumb-turns will prevent the door being unlocked if the room occupant forcibly restricts thumb-turn movement. By applying force to the thumb-turn it prevents operation of the lock device (whether key operated or a bathroom-type privacy lock) and prevents the door being unlocked. This barricade-type situation is a serious potential problem in buildings used by vulnerable groups such as children and especially in mental health facilities, posing a real health and safety risk to both staff and occupants.

### SUMMARY OF THE INVENTION

This invention proposes an anti-barricade thumb-turn that enables operation of the door lock device it is fitted to, even if force is applied to the thumb-turn by a room occupant attempting to prevent the door being unlocked in a barricade situation.

This invention provides a thumb-turn that will prevent the occurrence of a barricade situation, being a mechanism that enables operation of the door lock device the thumb-turn is fitted to, even if a room occupant resists by applying force to the thumb-turn. This Invention is particularly applicable for buildings used by vulnerable groups such as children, the elderly and mental health facilities.

Preferably, the invention can be used in the manufacture of new thumb-turns. The invention may also be applied retrospectively in that the anti-barricade thumb-turn can replace existing standard thumb-turns.

These and other objects, aspects and advantages of the present invention will be better appreciated in view of the drawings, and following detailed description of a preferred embodiment.

### BRIEF DESCRIPTION OF THE DRAWINGS

FIG. 1 is an end-on view of the anti-barricade thumb-turn; and

FIG. 2 is an oblique lateral view of the anti-barricade thumb-turn and components.

### DETAILED DESCRIPTION OF A PREFERRED EMBODIMENT

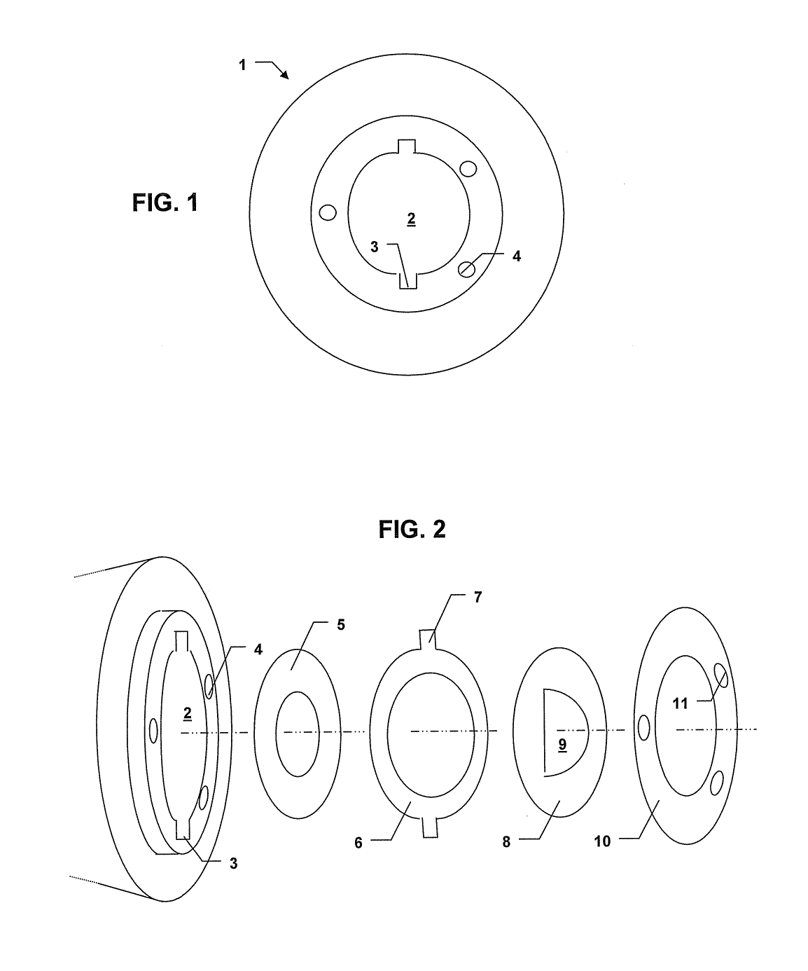

FIG. 1 represents a view of the underside of the anti-barricade thumb-turn's main body (1). In both FIGS. 1 and 2 the upper part of the thumb-turn main body (1) is not represented since the shape and style of the actual thumb-turn will vary according to aesthetic preferences or other considerations—for example a rounded style anti-ligature type knob would be chosen for use in mental health facilities.

The underside of the thumb-turn has a circular inner bore (2) of a depth and diameter that will accommodate the inner components and also, when fitted to the door lock, accommodate the lock spindle. The inner bore has one or more lug slots (3) extending its full depth. The main body of the thumb-turn around the inner bore has one or more threaded screw holes (4).

FIG. 2 represents an oblique lateral view of the underside of the thumb-turn and the components of the anti-barricade mechanism that are inserted into the inner bore (2). The circular spring component (5) has a maximum diameter that is equal to or less than the diameter of the inner bore (2). The spring component may be a disc spring, coil spring, rubber O-ring or similar, its function being to provide sufficient pressure when inserted into the inner bore that it pushes the drive plates together.

The circular thumb-turn drive plate (6) has one or more lugs (7) extending radially outwards from the outermost circumference—the number and spatial positioning of the lugs (7) corresponding to the number and spatial positioning of the lugs slots (3) on the inner bore. Therefore when the thumb-turn drive plate is inserted into the inner bore the lug or lugs (7) locate within the lug slot or slots (3) to provide a drive function when the thumb-turn knob is rotated. The thumb-turn drive plate has a diameter (excluding the lugs) that is equal to the diameter of the inner bore. The lug or lugs have dimensions that are equal to, or less than, the dimensions of the lug slot or slots in the inner bore.

The circular spindle-drive plate (8) has a maximum diameter equal to or less than the diameter of the inner bore. The centre of the spindle-drive plate has a cut-out portion which will be one of several different profiles (9). The correct profile of spindle-drive plate is selected for use depending on the shape of the spindle in the door lock that the thumb-turn is to be fitted to. For instance in this representation the spindle-drive plate has a D-shaped inner profile which fits a particular type of cylinder lock, while other profiles include a rectangular slot or a square to fit other door lock devices. Having a range of spindle-drive plate profiles thereby allows the Invention to be used in conjunction with any number of commercially available door lock mechanisms. It is the spindle-drive plate (8) that provides the drive function for the spindle of the door lock device.

The spring component (5), thumb-turn drive plate (6) and spindle-drive plate (8) are inserted into the inner bore—if necessary using multiple drive plates such that all components are in contact with each other and the inner bore is full to its entire depth. The components inside the inner bore are secured by a retaining ring (10) by means of one or more screws locating through the retaining ring holes (11) into the threaded screw holes (4) on the main thumb-turn body. The diameter across the inner circumference of the retaining ring is equal to the diameter of the inner bore.

When the thumb-turn is assembled the spring component (5) provides sufficient pressure to hold the thumb-turn drive plate(s) (6) against the spindle drive plate(s) (8) such that when one rotates the friction forces are sufficient to rotate the other also. Therefore when the thumb-turn is rotated under normal operation, the thumb-turn drive plate(s) also causes the spindle drive plate(s) to also rotate and operate the lock device. The room occupant can therefore lock and unlock the door by means of the thumb-turn.

Similarly, if the key/release mechanism on the lock device is operated from the other side of the door, the rotating spindle drive plate(s) cause the thumb-turn drive plate(s) to rotate and also the thumb-turn. A person outside the room can therefore lock and unlock the door.

In a barricade situation a room occupant applies force to the thumb-turn in an attempt to prevent the lock spindle rotating and unlock the door. In this event, with this invention, even if the thumb-turn and thumb-turn drive plate(s) are fully immobilised by a room occupant, the spindle thumb-turn drive plate(s) and spindle drive plate(s) simply slip against each other since the friction forces between the drive plates is less than the force by which the spindle is being rotated. Hence the lock spindle can still be rotated as the person on the outside of the door operates the key/release mechanism and thereby the door can be unlocked despite resistance by the room occupant.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and the claims appended hereto.

What is claimed is:

1. An anti-barricade thumb-turn enabling operation of the door lock device it is fitted to, even if force is applied to the thumb-turn.

2. An anti-barricade thumb-turn according to claim 1, enabling operation of the door lock device it is fitted to, even if force is applied to the thumb-turn, and comprising a thumb-turn with a spring component, thumb-turn drive plate or plates and spindle-drive plate or plates inserted into the inner bore on its underside and secured in position by means of a retaining ring.

3. An anti-barricade thumb-turn according to claim 1 and comprising a thumb-turn with components inserted into its inner bore being a circular spring component with a maximum diameter equal to or less than the diameter of the inner bore, and one or more circular thumb-turn drive plates with a diameter (excluding lugs) equal to the diameter of the inner bore and one or more lugs extending radially from the outer circumference the dimensions of which are equal to, or less than, the dimensions of the lug slot or slots that extend the length of the inner bore, and one or more circular spindle-drive plates with a maximum diameter equal to, or less than, the diameter of the inner bore and a central cut-out portion wherein said components are secured within the inner bore by means of a circular retaining ring of which the diameter across the inner circumference is equal to the diameter of the inner bore.
